(19) United States
(12) Patent Application Publication
(10) Pub. No.: US 2025/0240606 A1
(43) Pub. Date: Jul. 24, 2025

(54) METHOD AND APPARATUS FOR PROVIDING SENSING SERVICE, COMMUNICATION DEVICE, AND STORAGE MEDIUM

(71) Applicant: Jianning LIU

(72) Inventor: Jianning LIU

(21) Appl. No.: 18/702,165

(22) PCT Filed: Oct. 18, 2021
(86) PCT No.: PCT/CN2021/124508

§ 371 Date: Apr. 17, 2024

(51) Int. Cl. H04W 4/38; G01S 7/00; G01S 13/86

(52) U.S. Cl. CPC H04W 4/38; G01S 7/006; G01S 13/86

(57) ABSTRACT

A method for providing a sensing service includes receiving a first sensing request by a first function, where the first sensing request is used for requesting the sensing service; determining a target second function by the first function; and sending, by the first function, a second sensing request to the target second function according to the first sensing request.

### CROSS-REFERENCE TO RELATED APPLICATION

The present application is a U.S. National Stage of International Application No. PCT/CN2021/124508, filed on Oct. 18, 2021, the entire content of which is incorporated herein by reference for all purposes.

### BACKGROUND

Currently, with the development of artificial intelligence (AI) technologies, the intelligence of many industries is greatly promoted, and the sensing technology has become an important technical basis, for example, the radar-based technology is widely used in the intelligent transport field and the autonomous driving field, etc. The current radar-based sensing technology mainly relies on a dedicated radar device, which is high in cost and inflexible in deployment, and is mainly used in specific scenarios.

In the mobile Internet era, with the development of mobile communications, much larger number of mobile terminals and mobile base stations will be provided in the future, and at the same time, with the continuous emergence of new services, sensing demands are also gradually strong. For example, sensing services may be used to sense the surrounding objects in the dark. For another example, sensing the human body action instruction indoors to control smart furniture, etc., which provides a great convenience for daily life.

### SUMMARY

The present disclosure relates to, but is not limited to, the field of wireless communication technologies, and in particular relates to a method and apparatus for providing a sensing service, a communication device, and a storage medium. Embodiments of the present disclosure provide a method and apparatus for providing a sensing service, a communication device, and a storage medium.

A first aspect of the embodiments of the present disclosure provides a method for providing a sensing service, performed by an access management function (AMF), where the method includes:
receiving a sensing request, where the sensing request at least includes a user equipment (UE) identification and a base station identification;
determining a target sensing function (SF); and
sending the sensing request to the target SF.

A second aspect of the embodiments of the present disclosure provides a method for providing a sensing service, performed by an SF, where the method includes:
receiving a sensing request, where the sensing request at least includes a UE identification and a base station identification;
determining a sensing parameter according to the sensing request; and
sending the sensing parameter to the UE and the base station.

A third aspect of the embodiments of the present disclosure provides a method for providing a sensing service, performed by a base station, where the method includes:
sending to an AMF a sensing request that is from a UE;
receiving a sensing response returned by an SF for the sensing request;
obtaining from the sensing response a sensing parameter used for the base station to provide the sensing service; and
sending to a UE a sensing parameter that is in the sensing response and used for the UE to provide the sensing service.

A fourth aspect of the embodiments of the present disclosure provides a method for providing a sensing service, performed by a UE, where the method includes:
sending through a base station a sensing request to an AMF, where the sensing request at least includes a UE identification and a base station identification, and is used for the AMF to determine a target SF for providing a sensing parameter required for the sensing service.

A fifth aspect of the embodiments of the present disclosure provides an apparatus for providing a sensing service, where the apparatus includes:
a first receiving module, configured to receive a sensing request, where the sensing request at least includes a UE identification and a base station identification;
a first determining module, configured to determine a target SF; and
a first sending module, configured to send the sensing request to the target SF.

A sixth aspect of the embodiments of the present disclosure provides an apparatus for providing a sensing service, where the apparatus includes:
a second receiving module, configured to receive a sensing request, where the sensing request includes a UE identification and a base station identification;
a third determining module, configured to determine a sensing parameter according to the sensing request; and
a second sending module, configured to send the sensing parameter to the UE and the base station.

A seventh aspect of the embodiments of the present disclosure provides an apparatus for providing a sensing service, performed by a base station, where the apparatus includes:
a third sending module, configured to send to an AMF a sensing request that is from a UE;
a third receiving module, configured to receive a sensing response returned by an SF for the sensing request; and
an obtaining module, configured to obtain from the sensing response a sensing parameter used for the base station to provide the sensing service; where
the third sending module is further configured to send to a UE a sensing parameter that is in the sensing response and used for the UE to provide the sensing service.

An eighth aspect of the embodiments of the present disclosure provides an apparatus for providing a sensing service, where the apparatus includes:
a fourth sending module, configured to send through a base station a sensing request to an AMF, where the sensing request at least includes a UE identification and a base station identification, and is used for the AMF to determine a target SF for providing a sensing parameter required for the sensing service.

A ninth aspect of the embodiments of the present disclosure provides a communication device that includes a processor, a transceiver, a memory, and an executable program stored in the memory and capable of being executed by the processor, where the processor, through executing the executable program, performs the method for providing the sensing service provided in any aspect of the first to fourth aspects as described above.

A tenth aspect of the embodiments of the present disclosure provides a computer storage medium, where the computer storage medium stores an executable program, and the executable program, when executed by a processor, is capable of implementing the method for providing the sensing service provided in any aspect of the first to fourth aspects as described above.

It should be understood that the above general description and the later detailed description are exemplary and explanatory only, and do not limit the embodiments of the present disclosure.

### BRIEF DESCRIPTION OF THE DRAWINGS

The accompanying drawings herein, which are incorporated into and form a part of the specification, illustrate principles that are in accordance with the embodiments of the present invention and are used in conjunction with the specification to explain the embodiments of the present invention.

FIG. 1 is a schematic structural diagram of a wireless communication system illustrated according to an embodiment.

FIG. 2 is a schematic diagram of a system architecture for providing a sensing service illustrated according to an embodiment.

FIG. 3 is a schematic flow diagram of a method for providing a sensing service illustrated according to an embodiment.

FIG. 4 is a schematic diagram of a method for providing a sensing service based on a radar signal illustrated according to an embodiment.

FIG. 5 is a schematic diagram of a UE and a base station jointly providing a sensing service illustrated according to an embodiment.

FIG. 6 is a schematic flow diagram of a method for providing a sensing service illustrated according to an embodiment.

FIG. 7 is a schematic flow diagram of a method for providing a sensing service illustrated according to an embodiment.

FIG. 8 is a schematic flow diagram of a method for providing a sensing service illustrated according to an embodiment.

FIG. 9A is a schematic flow diagram of a method for providing a sensing service illustrated according to an embodiment.

FIG. 9B is a schematic flow diagram of a method for providing a sensing service illustrated according to an embodiment.

FIG. 10 is a schematic flow diagram of a method for providing a sensing service illustrated according to an embodiment.

FIG. 11 is a schematic structural diagram of an apparatus for providing a sensing service illustrated according to an embodiment.

FIG. 12 is a schematic structural diagram of an apparatus for providing a sensing service illustrated according to an embodiment.

FIG. 13 is a schematic structural diagram of an apparatus for providing a sensing service illustrated according to an embodiment.

FIG. 14 is a schematic structural diagram of an apparatus for providing a sensing service illustrated according to an embodiment.

FIG. 15 is a schematic structural diagram of a UE illustrated according to an embodiment.

FIG. 16 is a schematic structural diagram of a network element illustrated according to an embodiment.

### DETAILED DESCRIPTION

Exemplary embodiments are explained in detail here, examples of which are indicated in the accompanying drawings. When the following description involves the accompanying drawings, the same numerals in different accompanying drawings indicate the same or similar elements unless otherwise indicated. The embodiments described in the following exemplary embodiments do not represent all embodiments consistent with the embodiments of the present invention. On the contrary, they are only examples of devices and methods consistent with some aspects of the embodiments of the present invention as detailed in the attached claims.

The terms used in the embodiments of the present disclosure are used solely for the purpose of describing particular embodiments and are not intended to limit the embodiments of the present disclosure. The singular forms of “a” and “the” used in the embodiments of the present disclosure and the appended claims are also intended to include the majority form, unless the context clearly indicates other meanings. It should also be understood that the term “and/or” as used herein refers to and includes any or all possible combinations of one or more of the associated listed items.

It should be understood that although the terms first, second, third, etc. may be used in the embodiments of the present disclosure to describe various types of information, such information should not be limited to these terms. These terms are only used to distinguish the same type of information from one another. For example, without departing from the scope of the embodiments of the present disclosure, the first information may also be referred to as the second information, and similarly, the second information may also be referred to as the first information. Depending on the context, the phrase “if” as used herein may be interpreted as “at the time of . . . ” “when . . . ”, or “in response to determining”.

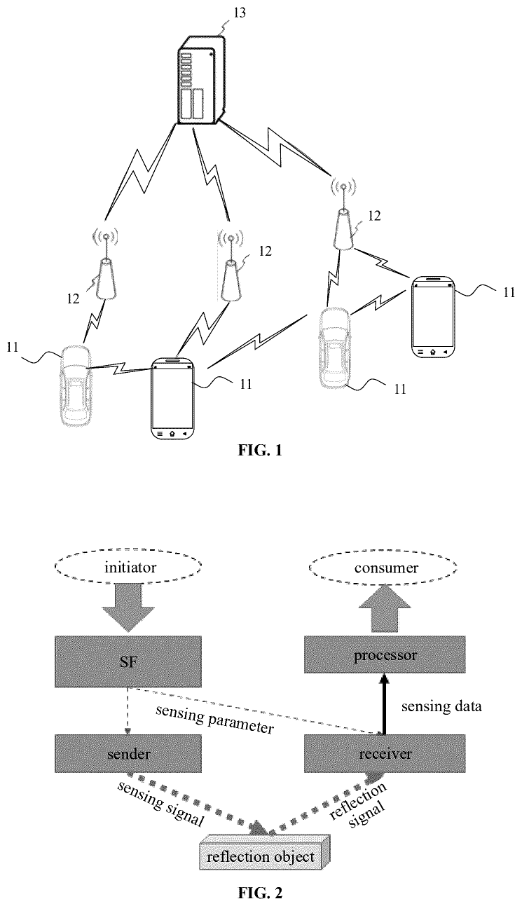

Referring to FIG. 1, a schematic structural diagram of a wireless communication system provided in an embodiment of the present disclosure is shown. As shown in FIG. 1, the wireless communication system is a communication system based on cellular mobile communication technologies, and the wireless communication system may include one or more UEs 11 and one or more access devices 12.

In some embodiments, the UE 11 may be a device that provides voice and/or data connectivity to a user. The UE 11 may communicate with one or more core networks via a radio access network (RAN). The UE 11 may be an IoT (internet of things) UE, such as a sensor device, a mobile phone (also known as the “cellular” phone), or a computer with an IoT UE. For example, the UE 11 may be a fixed, portable, pocket, handheld, computer built-in, or vehicle-mounted device. For example, the UE 11 may be a station (STA), a subscriber unit, a subscriber station, a mobile station, a mobile, a remote station, an access point, a remote terminal, an access terminal, a user terminal, a user agent, a user device, or a user equipment (UE). Or, the UE 11 may be a device of an unmanned aerial vehicle. Or, the UE 11 may be a vehicle-mounted device, such as a trip computer with wireless communication functions or a wireless communication device externally connected to a trip computer. Or, the UE 11 may be a road side device, such as a street light, a signal light, or other road side devices with wireless communication functions.

The access device 12 may be a network side device in the wireless communication system. In some embodiments, the wireless communication system may be the 4th generation (4G) mobile communication system, also known as the long term evolution (LTE) system. Or, the wireless communication system may be a 5G system, also known as a new radio (NR) system or a 5G NR system. Or, the wireless communication system may be the next generation system of the 5G system. In some embodiments, the access network in the 5G system may be called as the new generation-radio access network (NG-RAN), or the MTC system.

In some embodiments, the access device 12 may be an evolved access device (eNB) used in a 4G system. Or, the access device 12 may be an access device (gNB) with a centralized distributed architecture in a 5G system. When adopting the centralized distributed architecture, the access device 12 typically includes a central unit (CU) and at least two distributed units (DUs). The central unit is provided with a protocol stack of a packet data convergence protocol (PDCP) layer, a radio link control (RLC) layer, and a media access control (MAC) layer. The distributed unit is provided with a protocol stack of a physical (PHY) layer. The embodiments of the present disclosure do not limit the specific implementations of the access device 12.

A wireless connection may be established between the access device 12 and the UE 11 via a wireless air interface. In a different embodiment, the wireless air interface is based on the 4th generation (4G) mobile communication network technology standard. Or, the wireless air interface is based on the 5th generation (5G) mobile communication network technology standard, for example, the wireless air interface is a new air interface. Or, the wireless air interface may also be a wireless air interface of the next generation mobile communication network technology standard based on 5G.

In some embodiments, an end to end (E2E) connection may also be established between UEs 11. For example, scenarios such as vehicle to vehicle (V2V) communications, vehicle to infrastructure (V2I) communications, and vehicle to pedestrian (V2P) communications in the vehicle to everything (V2X) communications.

In some embodiments, the above-described wireless communication system may further include a network management device 13.

One or more access devices 12 are connected to the network management device 13 respectively. In some embodiments, the network management device 13 may be a core network device in the wireless communication system, for example, the network management device 13 may be a mobility management entity (MME) in the evolved packet core (EPC). Alternatively, the network management device may also be other core network devices, such as a service gateway (SGW), public data network gateway (PGW), policy and charging rules function (PCRF), or home subscriber server (HSS), etc. The implementation forms of the network management device 13 are not limited by the embodiments of the present disclosure.

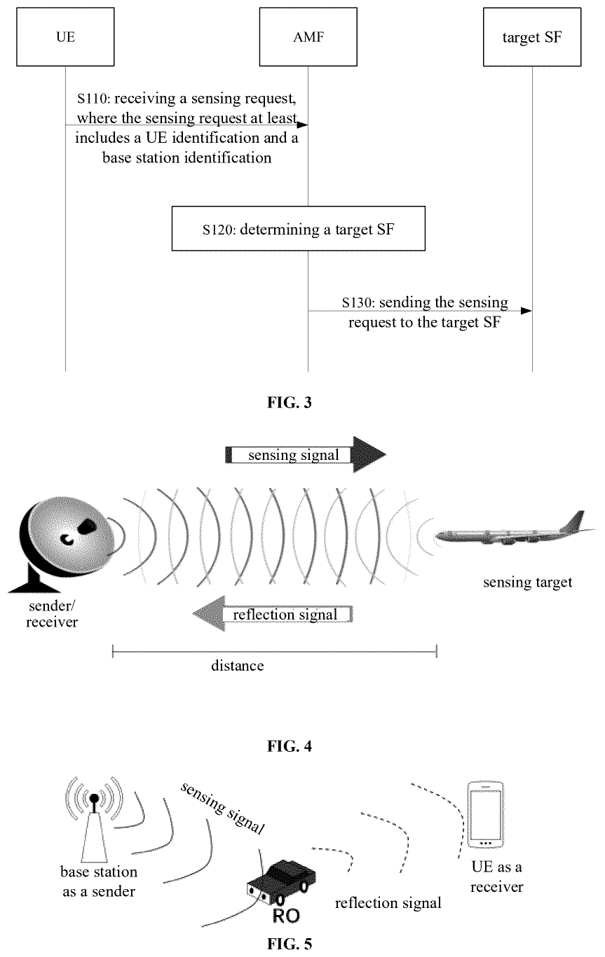

The wireless sensing method provided by the embodiments of the present disclosure may be applied in a system architecture as shown in FIG. 2, but is not limited to the system architecture shown in FIG. 2.

Initiator: the initiator triggers a sensing service based on an application requirement, and may be outside of a communication system corresponding to 3GPP.

Consumer: the consumer receives and consumes output data of the sensing service, where the data may include sensing data and/or a sensing result generated based on the sensing data.

Sensing Function (SF): the sensing function may be any functional entity at the network side and is a type of network function, and the sensing function determines, based on the information/requirement provided by the initiator, a sensing model, a sensing parameter of a sender (also known as a sending device or a sending apparatus) and a sensing parameter of a receiver (also known as a receiving device or a receiving apparatus).

Sender: the sender sends a sensing signal based on the sensing parameter received from the SF.

Receiver: the receiver receives a reflection signal based on the sensing parameter received from the SF, and sends, if there is any sending data, the sensing data to the processor.

Processor: the processor processes the sensing data received from the receiver and outputs the sensing result. It is noteworthy that the processor herein may include one or more processors, or one or more processing devices.

It is noteworthy that a device may serve as one or more roles of the initiator, the consumer, the sender, the receiver, and the processor.

As shown in FIG. 3, the embodiments of the present disclosure provide a method for providing a sensing service that is executed by an AMF, and the method includes the following steps S110 to S130.

At step S110, a sensing request is received, where the sensing request at least includes a UE identification and a base station identification.

At step S120, a target SF is determined.

At step S130, the sensing request is sent to the target SF.

The sensing request may be from an initiator or a consumer of the sensing service, and specifically may be from a UE or an application function (AF) of the sensing service.

The sensing request may be from a UE that requests the sensing service or a UE that may provide the sensing service to another UE.

The UE identification and the base station identification carried in the sensing request may be an identification of a candidate UE and an identification of a candidate base station for providing the sensing service.

The UE identification includes, but is not limited to, an international mobile equipment identity (IMEI) and/or an international mobile subscriber identity (IMSI) of the UE, or a temporary mobile subscriber identity (TMSI).

The base station identification may be a device identification of a base station and/or a cell identification of a cell formed by the base station. The cell identification includes, but is not limited to, a physical cell identification (PCI).

If a sensing request is received, where the sensing request carries the UE identification and the base station identification, the target SF may be defaulted as that the current sensing request preferentially requests using the base station and the UE jointly to provide the sensing service, and therefore may preferentially determine the sensing parameter that is applicable to the joint providing of the sensing service by the base station and the UE.

In the embodiments of the present disclosure, the AMF itself does not participate in providing sensing parameter, and may, after receiving the sensing request, determine the target SF and send the sensing request to the target SF.

The AMF, upon receiving the sensing request, may determine the target SF for providing the sensing parameter, and then send the sensing request including the UE identification and the base station identification to the target SF, such that the target SF may determine, based on the UE identification and the base station identification carried in the sensing request, to introduce the base station and the UE into the provision system of the sensing service to provide the sensing service.

FIG. 4 shows a wireless sensing based on radar waves.

A sender sends a radar signal, the radar signal may be reflected or absorbed when it encounters an obstacle during transmission, the reflected radar wave may be received by a receiver, and the receiver, based on the received radar wave, may realize functions such as radar ranging, radar detection, etc., so as to know parameters such as where the obstacle is located, the volume and/or shape of the obstacle, and so on.

A sender sends a radar signal, the radar signal may be reflected or absorbed when it encounters an obstacle during transmission, the reflected radar wave may be received by a receiver, and the receiver, based on the received radar wave, may realize functions such as radar ranging, radar detection, etc., so as to know parameters such as where the obstacle is located, the volume and/or shape of the obstacle, and so on.

As shown in FIG. 4, information such as distances between the sensing target and devices where the sender and receiver are located, and directions of the sensing target relative to the devices where the sender and receiver are located may be determined based on sending time and receiving time of the radar wave.

Exemplarily, specific uses of the sensing service described in the embodiments of the present disclosure include, but are not limited to, at least one of:
detecting flying vehicles;
obstacle detection;
missile launch;
spaceship navigation;
marine navigation;
autonomous driving;
weather detection; or
terrain detection, etc.

The AMF, as a function of access and mobility management for the UE, may select as required an SF suitable to provide the sensing parameter for the UE.

The sensing request may be any request that requests to provide the sensing parameter and/or the sensing service. The sensing request may be a non-access layer (NAS) message and/or an access layer (AS) message.

The SF may be any functional entity at the network side, and specifically, for example, the SF may serve as one of the network elements of the core network and/or the access network.

Exemplarily, the sensing function includes, but is not limited to, at least one of:
an access function (AF);
a policy control function (PCF); or
other network functions (NFs).

Of course, the above are only examples, and specific implementations are not limited to these. In some embodiments, the SF may be other network elements independent of the access function (AF), the AMF, or the PCF.

In an embodiment, the sensing request further includes sensing model information, where the sensing model information indicates a sensing model for use in providing the sensing service.

In this embodiment, the sensing model is: a UE sending a sensing signal, and a base station receiving a reflection signal of the sensing signal sent by the UE; or a base station sending a sensing signal, and a UE receiving a reflection signal of the sensing signal sent by the base station.

The sensing model indicated by the sensing model information carried in the sensing request in the embodiments of the present disclosure may indicate using one of the base station or the UE as the sender of the sensing signal and the other as the receiver of the reflection signal formed by the sensing signal.

FIG. 5 shows that the base station serves as the sender of a sensing signal and the UE serves as the receiver of the sensing signal. A reflection object (RO), after being acted on by the sensing signal, may reflect the sensing signal, and the propagation direction of the sensing signal, etc., changes, which may generate a reflection signal that is received by the UE.

In a specific implementation, the UE may send a sensing signal, while the UE receives the reflection signal.

In some embodiments, the sensing model for providing the sensing service may include at least one of:
a first sensing model in which a base station serves as a sender and a receiver;
a second sensing model in which a UE serves as a sender and a receiver;
a third sensing model in which a base station serves as a sender and the UE serves as a receiver;
a fourth sensing model in which a UE serves as a receiver and a base station serves as a sender; or
a fifth sensing model other than the first sensing model to the fourth sensing model.

If a base station serves as both the sender and the receiver, it is equivalent to the sensing service being completely executed by the network element of the mobile communication network system.

In the first sensing model, a processor may also be involved, and the processor may be a base station, a computing device in the vicinity of the base station, or a UE, etc. The computing device includes, but is not limited to, an edge computing device or a computing device located in a remote connection.

In the second sensing model in which the UE serves as both the sender and the receiver, at least the sending and receiving of the sensing signal are performed by one or more UEs. In this case, the UE serving as the sender and the UE serving as the receiver in the second sensing model may be the same UE or different UEs. In the embodiments of the present disclosure, the UE that sends the sensing request may be at least one of the sender or the receiver. Exemplarily, the UE may serve as both the sender and the receiver.

In the second sensing model, a processor may also be involved, and the processor may be a UE, a base station, or a computing device connected to the base station. The computing device includes, but is not limited to, an edge computing device or a computing device located in a remote connection.

The third sensing model involves a base station and a UE, with the base station serving as the sender and the UE serving as the receiver. In this case, the base station that serves as the sender may send sensing signals to a plurality of UEs, thereby achieving one-to-many sensing service provision, and providing sensing services to different UEs.

In the third sensing model, a processor may also be involved, and the processor may be a UE, a base station, or a computing device connected to the base station. The computing device includes, but is not limited to, an edge computing device or a computing device located in a remote connection.

The fourth sensing model involves a base station and a UE, with the base station serving as the receiver and the UE serving as the sender. In this case, the base station that serves as the sender, due to its own powerful receiving capability, may receive sensing signals sent by a plurality of UEs at one time, thereby achieving one-to-many sensing service provision, and providing sensing services to different UEs.

In the fourth sensing model, a processor may also be involved, and the processor may be a UE, a base station, or a computing device connected to the base station. The computing device includes, but is not limited to, an edge computing device or a computing device located in a remote connection.

The fifth sensing model may be any sensing model other than the aforementioned first to fourth sensing models.

Exemplarily, the fifth sensing model may include a sensing model involving a plurality of senders and/or a plurality of receivers, and the plurality of senders may be of different types, e.g., the sender may include the UE and may also include the base station; and/or the receiver may include the UE and may also include the base station. Of course, the devices serving as the sender and the receiver include, but are not limited to, the base station and/or the UE. In a specific implementation, the devices serving as the sender and/or the receiver may also be road side devices capable of establishing connections with the base station or the UE. For example, a monitoring device having wireless signal sending and receiving capabilities at the road side, etc. The monitoring device includes, but is not limited to, a visual monitoring device mainly for image acquisition, etc.

The sensing request described in the embodiments of the present disclosure carries the UE identification and the base station identification, i.e., the initiator of the sensing service expects that the third sensing model and the fourth sensing model are preferentially used.

In some embodiments, the ranking of the UE identification and the base station identification in the sensing request or the fields used by the UE identification and the base station identification in the sensing request in the embodiments of the present disclosure may be used for the target SF to determine whether the sensing model expected to be used by the sender of the sensing request is the third sensing model or the fourth sensing model. For example, a sender field and a receiver field may be set in the sensing request, and in this case, the sensing model may be determined based on which fields the UE identification and the base station identification are carried in. For another example, the UE and the network device may pre-negotiate that the top ranked identification in the sensing request is the sender or receiver, and the other is the receiver or sender. In this case, the sensing model that is most expected by the sender of the sensing request for use may be determined based on the ranking of the UE identification and the base station identification in the sensing request.

In other embodiments, the sensing request carries the sensing model information directly, and the sensing model information may be an identification of the sensing model, such that the sensing model expected by the initiator of the sensing request for use may be determined directly based on the identification of the sensing model.

In an embodiment, the sensing request may carry sensing model information of one or more sensing models, and the sensing model information carried in the sensing request may all be the sensing model expected by the sender of the sensing request for use, so that when one of the sensing models is unavailable, the network side element such as the AMF or the SF, etc. may have another sensing model expected by the sender of the sensing request for use, thereby improving service quality of the sensing service.

In some embodiments, if the sensing service cannot be provided by using the sensing model indicated in the sensing request due to various information such as a network side condition, etc., the network side element such as the AMF or the SF, etc. may determine, based on the current network condition and target information of the sensing target carried in the sensing request, etc., another sensing model that can perform sensing for the sensing target, thereby achieving the providing of the sensing service.

The sensing request may be one or more kinds of the above information; of course, the sensing request may not carry the above information, and simply carry a request signaling of the sensing service.

In some embodiments, the request parameter may further include consumer information that indicates the consumer of the sensing service. The sensing result of the sensing service will be sent to the consumer for use by the consumer.

In an embodiment, the initiator and the consumer may be the same or different.

Exemplarily, two obligatory fields and one or more optional fields are provided in the sensing request. The two obligatory fields may carry initiator information and consumer information respectively, while the optional field may carry various information such as the aforementioned sensing target information, etc. Of course, this is only an example, and the specific implementation is not limited to this.

By carrying one or more of the aforementioned request parameters, it is convenient for the SF to determine the sensing parameter that is suitable for the current scenario, thereby ensuring the service quality of the sensing service.

Exemplarily, the sensing target information includes at least one of:
the area of the sensing target;
the region information of the sensing target;
the position of the sensing target;
the volume of the sensing target; or
the speed of the sensing target.

In some embodiments, sensing targets with different areas and/or volumes may be used to determine parameters such as the view angle and/or power at which the sender sends the sensing signal.

The region information of the sensing target may indicate the region in which the sensing target is currently located, which may facilitate determining a sensing service region.

The position of the sensing target may be used for determining an executor, for example, selecting a suitable executor nearby to perform the sensing service.

The speed of the sensing target may have an impact on the successful provision of the sensing service, e.g., for the object that moves at a high speed, there is a requirement for the sending power of the sender in the sensing service. Additionally, there may be a Doppler effect due to the motion of the sensing target, and in this case, there is a certain requirement for the processing capability of the processor that provides the sensing service.

In some embodiments, the sensing target information is not limited to the area, position, volume, and/or speed described above, but may also include the type of the sensing target. For example, the type of the sensing target may be categorized as a static sensing target and a dynamic sensing target based on whether the sensing target moves or not. Depending on whether the sensing target is a living body, the type of the sensing target may be categorized as a living target and a non-living target. If the living target is targeted, it may be required to consider negative effect of the radar spot on the living body, etc.

In summary, the initiator may send the request parameter through the sensing request, the SF may determine the sensing parameter based on the request parameter and/or network information other than the request parameter, etc., and the executor is capable of providing, based on the sensing parameter, the sensing service with guaranteed security and quality of service.

In some embodiments, one or more of the request parameters in the sensing request may also be used for the AMF to determine the target SF. For example, the AMF selects, based on the position of the UE and/or the position of the sensing target indicated by the request parameter in the sensing request, the SF within a sensing region corresponding to the position of the UE and/or the position of the sensing target as the target service. As another example, the AMF selects, based on quality of service (QOS) of the sensing service indicated by the request parameter in the sensing request, the SF that is capable of providing the sensing service that satisfies the QoS indicated by the QoS information as the target SF. Of course, the above are only examples.

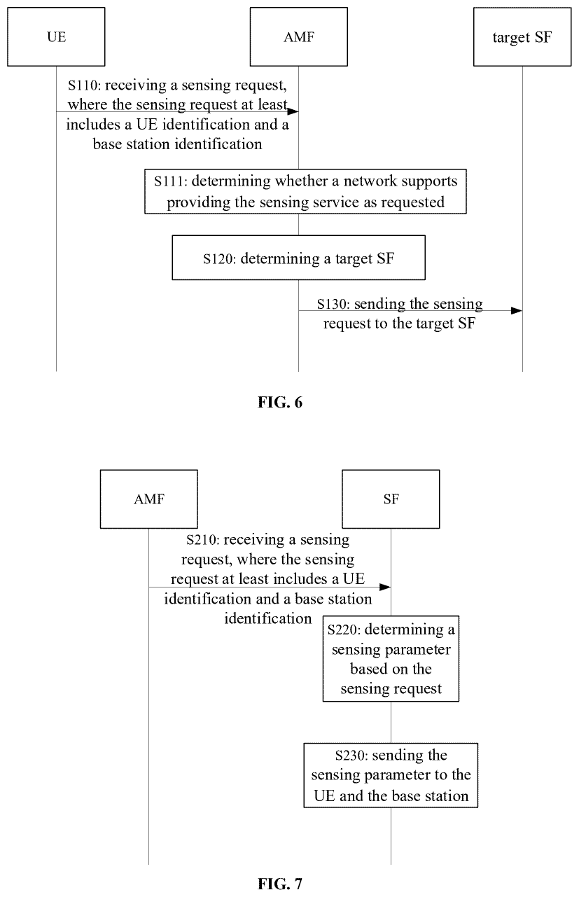

In some embodiments, as shown in FIG. 6, the method further includes step S111.

At step S111, whether a network supports providing the sensing service as requested is determined.

The step S120 may include: if the sensing service as requested is supported, determining the target SF.

In some embodiments, the network does not support providing the sensing service, and thus it is determined that the sensing request cannot be responded to, i.e., responding to the sensing request may be rejected. If the sensing request is rejected, a request rejection message may be sent to the UE, and the request rejection message may carry a reason value indicating the network not supporting providing the sensing service. The UE, upon receiving the request rejection message indicating the reason value of the network not supporting providing the sensing service, may not repeat sending the sensing request.

In other embodiments, the network supports providing the sensing service, it may be directly determined to respond to the sensing request, or whether to respond to the sensing request may be further determined based on other reference parameters such as the request parameter carried in the sensing request.

In an embodiment, determining whether the network supports providing the sensing service as requested includes at least one of: determining whether the network supports provision of the sensing service; or determining whether verification of the network side for providing the sensing service is passed.

The validation for providing the sensing service includes, but is not limited to, authority verification and/or privacy security verification.

In some cases, the network may not be configured with the provision of the sensing function, and in this case, the network does not support the provision of the sensing service.

In some embodiments, when the sensing service is requested by the sensing request, a recommended sensing model for use may be provided, and if the current network side, even though it supports the provision of the sensing service, does not support providing the sensing service by using the sensing model recommended by the UE, the network side may likewise reject to respond to the sensing request, and may determine to respond to the sensing request when the network side supports providing the sensing service by using the sensing model suggested by the UE.

In some embodiments, determining whether to respond to the sensing request further includes:
sending a query request to a user data management (UDM), where the query request at least carries the UE identification; and
receiving a query response returned based on the query request, where the query response is used for determining whether the verification is passed.

Based on whether the UE has contracted the sensing service, the UDM may provide contract data. The AMF may send the request information to the UDM to inquire whether the UE has contracted the sensing service, whether the UE is provided with the sensing service with the QoS requested by the UE, or whether the UE is provided with the sensing service provided by the sensing model that is recommended for use by the UE.

In an embodiment, the query response may include a query result that directly indicates whether the UE has contracted the sensing service.

In another embodiment, the query response may further include the contract data of the UE, and the contract data indirectly indicates whether the UE has contracted the sensing service. If the AMF receives the contract data, the AMF needs to determine, on its own by using the contract data, whether the UE has contracted the sensing service.

In some embodiments, the request information further includes the QoS information and/or the sensing model information included in the sensing request.

The QoS information is used for the UDM to determine whether the UE has contracted the sensing service that satisfies the QOS information.

The sensing model information is used for the UDM to determine whether the UE has contracted the sensing service that uses the sensing model indicated by the sensing model information.

If the UE contracts the sensing service of the QOS information, it means that the UE has the authority to request the sensing service indicated by the QOS information.

Exemplarily, different positioning accuracy degrees of the sensing services for the sensing target indicated by the QoS information correspond to different QoS levels.

Exemplarily again, different guaranteed bandwidths used for the sensing service indicated by the QoS information correspond to different QoS levels.

In an embodiment, step S120 may include selecting, based on at least one of the sensing request, an SF selection configuration of the AMF or a network discovery mechanism, the target SF from candidate SFs capable of providing the sensing service.

In an embodiment, the AMF may determine the target SF directly based on the sensing request. For example, determining the target SF based on the sensing request may include: determining a sensing region where the UE is located based on the UE identification included in the sensing request, and selecting one or more candidate SFs from the sensing region as the target SF; determining the target SF based on SF information indicated by the sensing request, where the SF information includes, but is not limited to, an identification of the SF.

The SF selection configuration may include: an SF selection configuration locally stored in the AMF; and/or an SF selection configuration requested from the PCF.

If the AMF locally stores the SF selection policy, the AMF may determine the target SF based on the SF selection policy alone, or determine the target SF based on the sensing request and the SF selection policy.

If the AMF does not locally store the SF selection configuration, the AMF requests the SF selection policy from the PCF, and receives policy information of the SF selection policy returned by the PCF and determines the target SF alone, or determines the target SF based on the sensing request and the policy information of the SF selection policy returned by the PCF.

The AMF may also determine the target SF based on the network discovery mechanism, exemplarily including, but not limited to, at least one of:
the AMF individually discovering, based on the network discovery mechanism alone, the target SF capable of providing the sensing service; or
the AMF discovering, based on the sensing request and the network discovery mechanism, the target SF capable of providing the sensing service requested by the request parameter of the sensing request.

Discovering the target SF based on the discovery mechanism may include, but is not limited to, at least one of:
the AMF sending a request message to a network repository function (NRF), where the request message may include attribute information of the target SF that the AMF needs to discover; or
receiving a response message returned by the NRF, where the response message may carry information of an SF capable of serving as the target SF queried by the NRF based on the attribute information. The information of the SF includes, but is not limited to, an identification of the SF and/or address information of the SF.

In an embodiment, the attribute information may be determined based on the sensing request. For example, the attribute information indicates the sensing region where the target SF is located, the type of the supported sensing model, and the QoS of the sensing service that can be provided.

In another embodiment, the attribute information may individually indicate a service identification of the sensing service, and the service identification is available to the NRF to determine the candidate SF capable of providing the sensing service.

Exemplarily, the target SF may have one of the following characteristics:
the target SF being located in the same sensing region as the UE;
the target SF being located in the same sensing region as the sensing target;
the target SF being the SF that is closest to the UE and capable of supporting provision of the sensing service requested by the UE;
the target SF being the SF that is closest to the AF or target server of the sensing service;
the target SF being the SF that is located in the same sensing region as the AF or target server of the sensing service; or
the target SF being the SF recommended by the UE.

In summary, in the embodiments of the present disclosure, the AMF may determine, based on at least one of the sensing request, the SF selection policy or the network discovery mechanism, the target SF that responds to the sensing request.

As shown in FIG. 7, the embodiments of the present disclosure provide a method for providing a sensing service that is performed by an SF, and the method includes steps S210 to S230.

At step S210, a sensing request is received, where the sensing request at least includes a UE identification and a base station identification.

At step S220, a sensing parameter is determined according to the sensing request.

At step S230, the sensing parameter is sent to the UE and the base station.

After receiving the sensing request from the UE forwarded by the AMF, the SF may determine the sensing parameter according to the sensing request and send the sensing parameter as determined to the executor that provides the sensing service. If the third sensing model and the fourth sensing model are used to provide the sensing service, it may be the UE represented by the UE identification and the base station represented by the base station identification to receive the sensing parameter. The sensing parameter may include at least one of:
a sending parameter that indicates, for example, a type of a sensing signal to be sent, a sending frequency, a general sending direction, and/or a sending time period;
a receiving parameter that indicates, for example, a receiving time period and/or a receiving frequency; or
a processing parameter that indicates, for example, a preset manner for processing sensing data.

If the target SF determines that the sensing model for providing the sensing service uses the third sensing model or the fourth sensing model, the sensing parameter includes:
a sending parameter when the UE is a sender, and a receiving parameter when the base station is a receiver; or
a receiving parameter when the UE is a receiver, and a sending parameter when the base station is a sender.

In some embodiments, the processing parameter may also be issued to the base station or the UE for processing of the sensing data by the base station or UE itself. It is worth noting that the UE and the base station that serve as the executors herein may be the UE and the base station indicated by the UE identification and the base station identification carried in the sensing request. The executor may also be a UE that is located in the vicinity of the UE indicated by the UE identification carried in the sensing request and is substitute for the UE as the executor, or a base station that may substitute for the base station indicated by the base station identification carried in the sensing request to provide the sensing service, for example, a base station in the vicinity of the base station indicated by the base station identification.

In some embodiments, the method includes:
when the UE is the sender and the base station is the receiver, sending the sending parameter to the UE, and sending the receiving parameter to the base station; or
when the UE is the receiver and the base station is the sender, sending the sending parameter to the base station, and sending the receiving parameter to the UE.

The sensing parameter sent to the UE may be forwarded or transparently transmitted by the base station. For example, the sensing parameter sent to the UE may be carried in an information element (IE) or container of a signaling sent to the base station.

In some embodiments, the sensing parameter further includes a processing parameter that is used for processing sensing data formed by a receiver through receiving a reflection signal.

The processing parameter is sent to the processor in the executors, the processor may be the sender, the receiver, or a third party other than the sender and the receiver. For example, the processing parameter may be directly the initiator and/or consumer of the sensing request or any network element within the mobile communication network.

In some embodiments, determining the sensing parameter according to the sensing request includes determining the sensing parameter based on the sensing request and/or a policy parameter.

The sensing parameter is determined based on candidate parameters provided by the sensing request, for example, at least one of the candidate parameters is determined as the sensing parameter; for another example, the executor that provides the sensing service and the sensing model for providing the sensing service are determined based on the identification of the candidate model and the device information of the candidate device carried in the sensing request.

Determining the sensing parameter based on the policy parameter may include:
selecting, based on one or more sets of candidate parameters provided by the policy parameter, a set of candidate parameters as the sensing parameter in a randomly determined or predefined manner; and/or
selecting a set of parameters as the sensing parameter from a range of the sensing parameter defined by the policy parameter.

Determining the sensing parameter based on the sensing request and the policy parameter may include at least one of:
determining whether the sensing request provides a candidate parameter that is included in the policy parameter, and if included in the policy parameter, determining the candidate parameter as the sensing parameter; and/or, if not included in the policy parameter, randomly selecting a set of parameters from the policy parameter as the sensing parameter, or selecting a set of parameters, from the policy parameter, that is closest to the candidate parameter as the sensing parameter.

The above are only examples of determining the sensing parameter based on at least one of the sensing request or the policy parameter, and specific implementations are not limited to the above examples.

In some embodiments, the policy parameter includes:
a local policy parameter of the SF; and/or
a policy parameter provided by a PCF.

The policy parameter may be locally stored in the SF or may be requested from the PCF.

The local policy parameter of the SF may be pre-configured in the SF or may be saved locally in the SF after the last request from the PCF.

If there is no policy parameter stored locally in the SF, the policy parameter may be requested from the PCF, or if the policy parameter stored locally in the SF is provided with a lower priority, a policy parameter with a higher priority may be requested from the PCF.

Of course, the above are only examples of sources and/or manners of obtaining the policy parameter, and specific implementations are not limited to these examples.

In some embodiments, determining the sensing parameter based on at least one of the sensing request or the policy parameter includes:
sending a policy request to the PCF based on the sensing request;
receiving a policy response returned by the PCF, where the policy response includes the policy parameter provided by the PCF; and
determining the sensing parameter based on the policy response.

Requesting the policy parameter from the PCF may be done by sending the policy request to the PCF. The policy request may be for UE granularity, or for UE group granularity. If the policy request is for the UE granularity, the policy request carries an identification of the corresponding UE, and if the policy request is for the UE group granularity, the policy request carries a group identification of the UE group. If the policy request is for the UE granularity, the policy parameter returned in the policy response applies only to the corresponding UE. If the policy request is for the UE group granularity, the policy parameter returned in the policy response is for all UEs within the UE group. A UE group may include one or more UEs.

In an embodiment, the sensing request includes the UE identification.

In this embodiment, the policy request includes the UE identification, and the policy response is returned based on the UE identification.

The policy request carries the UE identification, and the PCF may return the policy response for the UE based on the UE identification.

In some embodiments, if the AMF does not perform verification for providing the sensing service, the validation may be performed by the SF. Alternatively, after the AMF completes the validation for one time, the SF performs the validation again.

Exemplarily, the method further includes performing verification for an initiator of the sensing request; where the determining the sensing parameter according to the sensing request includes: after the verification is passed, determining the sensing parameter according to the sensing request.

The security of the sensing service can be ensured by the validation, and the security includes the security and/or privacy security of the service provision process, etc. The initiator may be validated, and the sensing parameter is determined only after the validation is passed. If the validation is not passed, the sensing parameter will not be provided.

Of course, in case the verification based on the identification of the initiator has been completed by the AMF, the SF may also directly determine the sensing parameter according to the sensing request without further verification.

The initiator may be the UE represented by the UE identification carried in the sensing request described above.

The SF may perform local verification, or may request the UDM to perform remote verification, etc.

If the remote verification is performed by the UDM, performing the verification for the initiator of the sensing request includes: sending a query request to a UDM; and receiving a query response to the query request, where the query response is used for determining whether the verification is passed.

Exemplarily, a contract query request is sent to the UDM based on the sensing request, and after receiving the contract query request, the UDM may query the contract data based on the UE identification, thereby obtaining the query response.

In an embodiment, the query response may include a verification result that may indicate whether the verification is passed or not.

In another embodiment, the query response may include the queried contract data, and the SF, after receiving the contract data, generates by itself, by processing the contract information, the verification result of whether the verification is passed or not. If the returned contract data indicates that the UE does not contract the sensing service, the verification result indicates a verification failure (i.e., the verification is not passed), and if the returned contract data indicates that the UE contracts the sensing service, the verification result indicates that the verification is passed.

The verification includes authority verification and/or privacy security verification.

The authority verification is a verification of whether the UE has authority to access the sensing service, and/or a verification of what kind sensing service authority the UE has.

The privacy security verification refers to information security issues such as whether the UE's request for obtaining the sensing service would make the privacy of other users or the user corresponding to that UE exposed, if not, the privacy security verification is deemed to be passed, otherwise the privacy security verification may be deemed to be not passed.

The sensing parameter further includes:
address information of an application function (AF), where the address information of the AF is used for the base station and/or the UE to establish a transmission link with the AF; and/or
   address information of an initiator of the sensing service, where the address information of the initiator is used for the base station and/or the UE to establish a transmission link with the initiator;
   where the transmission link as established is used for transmitting sensing data and/or a sensing result generated based on the sensing data.

If the sensing parameter includes address information, the address information may be used by the executor to send the sensing data and/or the sensing result to a party that needs to receive the sensing data and/or the sensing result.

Exemplarily, the address information is the address information of the AF, the executor may establish a transmission link with the AF based on the address information. If the address information is the address information of the initiator of the sensing service, the address information may be used for the executor to establish a transmission link with the AF.

For example, when the executor does not send the sensing data and/or the sensing result to the target SF, the target SF may carry the address information in the sensing parameter, so that the executor receives the address information and establishes a transmission link with the network element corresponding to the address indicated by the address information, and the transmission link includes, but is not limited to, a TCP connection or a UDP connection.

In some embodiments, the sensing result includes an intermediate result and/or a final result.

The intermediate result is obtained by performing preliminary processing to the sensing data, and the intermediate result does not include the final result indicative of a distance, orientation, and/or profile of the sensing target, but rather a non-final result obtained from some preliminary processing. The preliminary processing may include, valid data selection, abnormal data elimination, or preliminary result calculation for calculating the final result. For example, eliminating invalid data and selecting the sensing data that participates in the final result calculation as the result of the preliminary processing, and sending the result of the preliminary processing to the target SF, the AF, the initiator and/or the consumer.

The final result is obtained by processing the sensing data.

As shown in FIG. 8, the embodiments of the present disclosure provide a method for providing a sensing service that is performed by a base station, and the method includes steps S310 to S340.

At step S310, a sensing request that is from a UE is sent to an AMF.

At step S320, a sensing response returned by an SF for the sensing request is received.

At step S330, a sensing parameter used for the base station to provide the sensing service is obtained from the sensing response.

At step S340, a sensing parameter that is in the sensing response and used for a UE to provide the sensing service is sent to the UE.

The base station is a base station selected to participate in providing the sensing service, which may specifically be an eNB and/or a gNB.

Exemplarily, the base station may be a base station whose base station identification is carried in the sensing request, or a base station adjacent to a base station whose base station identification is carried in the sensing request.

But the base station is at least a serving base station of the UE sending the sensing request.

After receiving the sensing request sent by the UE, the base station transparently transmits or forwards the sensing request to the AMF.

The AMF may further send the sensing request to the SF, so that the SF, after determining the sensing parameter according to the sensing request, may return the sensing parameter by carrying the sensing parameter in the sensing response, thus the base station will receive the sensing response.

After receiving the sensing response, the base station may extract from the sensing response the sensing parameter used for the base station itself to provide the sensing service. At the same time, the base station may also extract from the sensing response the sensing parameter used for the UE to provide the sensing service, and send it to the UE. Exemplarily, the base station sends to the UE the sensing parameter that needs to be sent to the UE via an RRC message or a MAC CE, etc.

In some embodiments, the receiving the sensing response returned by the SF for the sensing request includes receiving the sensing response returned by the SF for the sensing request and sent by the AMF.

The sensing response is transparently transmitted or forwarded by the AMF.

In an embodiment, the method further includes at least one of:
sending a sensing signal based on the sensing parameter used for the base station to provide the sensing service;
obtaining sensing data by receiving, based on the sensing parameter used for the base station to provide the sensing service, a reflection signal formed by reflection of a sensing signal sent by the UE; or
obtaining a sensing result by processing the sensing data based on the sensing parameter used for the base station to provide the sensing service.

The base station may serve as both the sender and the processor, or the base station may serve as both the receiver and the processor; or the base station may serve alone as the processor, the sender or the receiver.

In an embodiment, the method further includes:
sending the sensing data to an application function (AF) or an initiator of the sensing service; or
sending the sensing result to the AF or the initiator of the sensing service.

The sensing result herein may be the intermediate result and/or the final result as previously described.

Before sending the sensing data and/or the sensing result to the AF and/or the initiator, the base station may establish, based on the address information in the sensing parameter, a transmission link with the AF and/or the initiator. The transmission link includes, but is not limited to, a TCP link and/or a UDP link.

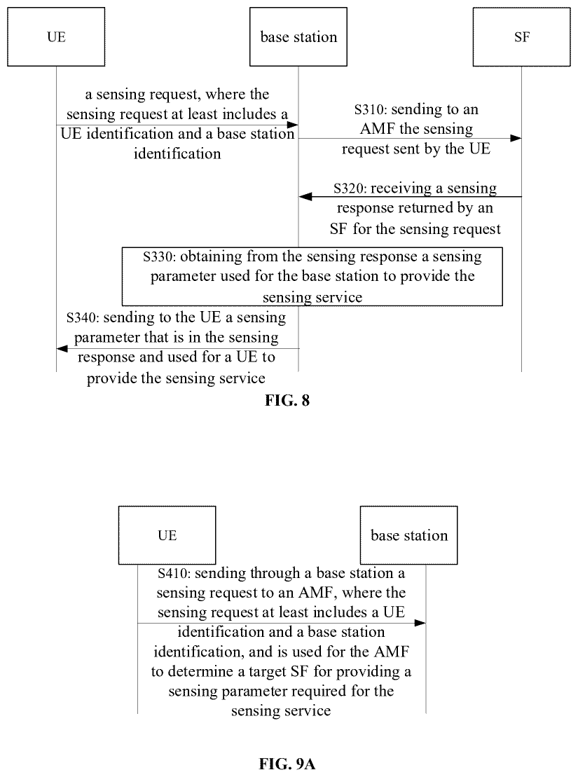

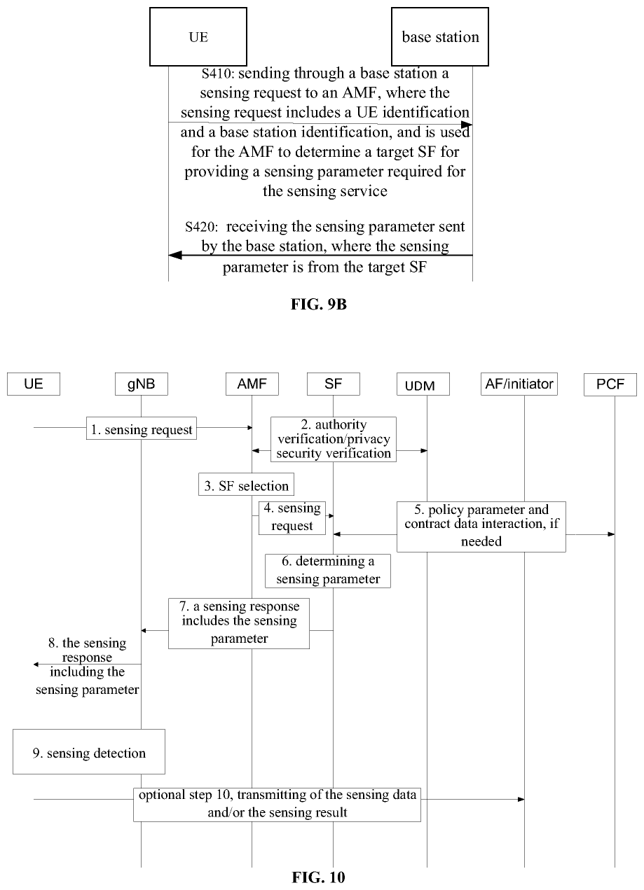

As shown in FIG. 9A, the embodiments of the present disclosure provide a method for providing a sensing service that is performed by a UE, and the method includes step S410.

At step S410, a sensing request is sent through a base station to an AMF, where the sensing request at least includes a UE identification and a base station identification, and is used for the AMF to determine a target SF for providing a sensing parameter required for the sensing service.

The UE herein may be the initiator of the sensing service, and is also the sender of the sensing request. In the embodiment of the present disclosure, the sensing request includes the UE identification and the base station identification, and the UE identification may be an identification of the UE that sends the sensing request, or an identification of another candidate UE that is known to the UE for being capable of being used for providing the sensing service.

The base station identification may be an identification of a candidate base station determined or expected by the UE to provide the sensing service, may be an identification of a serving base station of the UE, or may be an identification of an adjacent base station of the serving base station of the UE, e.g. an identification of a neighbor base station of the serving base station and the like. The above are of course only examples of UEs and base stations identified by the UE identification and the base station identification carried in the sensing request.

In summary, the sensing request carries the UE identification of a candidate UE capable of providing or expected to provide the sensing service, and the base station identification of a candidate base station capable of providing or expected to provide the sensing service.

In an embodiment, the sensing request includes at least one of:
sensing model information, indicating a sensing model of the sensing service;
QOS information, indicating QOS required for the sensing service;
the base station identification, indicating a base station capable of providing the sensing service; or
target information of a sensing target.

The detailed description of the sensing model, the QoS information, the base station identification, and the target information herein may be referred to any of the preceding embodiments.

In an embodiment, the method further includes receiving the sensing parameter sent by the base station, where the sensing parameter is from the target SF.

In an embodiment, as shown in FIG. 9B, the method further includes step S420.

At step S420, the sensing parameter sent by the base station is received, where the sensing parameter is from the target SF.

The sensing parameter that is provided by the target SF and determined according to the sensing request is issued through the base station, and thus the UE will receive from the base station the forwarded or transparently transmitted sensing parameter that is from the target SF.

After receiving the sensing parameter of the UE, the base station may directly transparently transmit or forward the sensing parameter.

Exemplarily, the sensing parameter may include at least one of:
a sending parameter, used for sending a sensing signal;
a receiving parameter, used for receiving a reflection signal formed based on the sensing signal; or
a processing parameter, used for processing sensing data formed by a receiver through receiving a reflection signal to obtain a sensing result, where the sensing result includes, but is not limited to, an intermediate result and/or a final result.

Therefore, in some embodiments, the method further includes at least one of:
sending a sensing signal based on a sending parameter in the sensing parameter;
obtaining sensing data by receiving a sensing signal based on a receiving parameter in the sensing parameter; or
obtaining a sensing result by processing the sensing data based on a processing parameter in the sensing parameter.

In some embodiments, the method further includes sending the sensing data to an application function (AF) or an initiator of the sensing service, or sending the sensing result to the AF or the initiator of the sensing service.

For example, the sensing parameter further includes address information, the address information may be used for the UE to establish a transmission link with the AF or initiator, and the transmission link may be used for the sending of the sensing data and/or the sensing result.

Referring to FIG. 10, the embodiments of the present disclosure provide a method for providing a sensing service, which may include the following steps 1 to 10.

At step 1, a sensing request from a UE is received, whether the UE is authorized to establish the sensing service is determined, and sending and receiving related parameter configuration and related policy information, etc. required for the UE and gNB to implement the sensing service are determined.

The STx in the system represents a sender of a sensing signal, and the SRx represents a receiver of a reflection signal formed by the sensing signal acting on a reflection object (RO), i.e., a sensing target.

In the embodiments of the present disclosure, a plurality of sensing models are provided based on different senders and receivers of the sensing signal and the reflection signal.

For example, the first sensing model: the UE being the STx, and the gNB being the SRx;
the second sensing model: both the STx and the SRx being the UE;
the second sensing model: both the STx and the SRx being the base station;
the fourth sensing model: the base station serving as the sender, and the UE serving as the receiver.
the fifth sensing model: any one of the sensing models other than the first sensing model to the fourth sensing model.

If the base station serves as the sender, the UE serves as the receiver; if the base station serves as the receiver, the UE serves as the sender.

The TRx/SRx refers to that the UE may serve as both a sensing information sender and a sensing information receiver, with the RO being the object being sensed.

An n service flow is as follows.

The sensing capability of each public land mobile network (PLMN) is assumed to change prior to the sensing request.

The UE initiates the sensing request to the AMF via the gNB, where the sensing request includes: the UE ID, the sensing model information indicative of the sensing model, and/or the QOS information of the sensing service.

The AMF checks whether the network supports the sensing service as requested, and if not, the AMF rejects the request. In detecting whether the network supports the sensing service as requested, authority verification/privacy security verification, as shown in step 2 of FIG. 10, may be used. For the implementation process of step 2, exemplarily, the AMF checks whether the UE has contracted the sensing service, whether the sensing service is allowed to be used, and whether the privacy security protection requirement is met; if the UE does not contract the sensing service, or the network prohibits providing the sensing service to the UE, or the provision of the sensing service may lead to privacy exposure or other issues that do not meet the privacy security protection requirement, the request is rejected; otherwise, the request may be accepted for providing the sensing service.

At step 3, the SF is selected, e.g., the AMF selects the SF based on the request, the local configuration/policy.

At step 4, the AMF sends the sensing request to the selected SF, where the sensing request includes the UE ID, the gNB ID, the sensing model information and/or the QoS information.

At optional step 5, the SF interacts the policy parameter and/or the contract data with the AF/initiator or the PCF, if needed, and specifically, for example, the SF obtains the policy parameter when needed, and obtains the contract data from the UDM when needed.

At step 6, a sensing parameter is determined, e.g., the SF determines a detailed configuration of the STx/SRx of the gNB and the UE. The detailed configuration may at least include the aforementioned sensing parameters for the UE and the base station to provide the sensing service.

At step 7, the gNB receives, through the AMF, a sensing response from the SF, where the sensing response includes the sensing parameter of the gNB and the sensing parameter of the UE. The sensing parameter may be carried in the IE of the sensing response, or in a container, and such a container carrying the sensing parameter may be called a sensing container.

At step 8, the UE receives the sensing response sent by the gNB, where the sensing response may at least include the sensing parameter of the UE.

At step 9, a sensing detection is performed, i.e., the UE and the gNB provide the sensing service, which may specifically include the UE and the gNB being responsible for sending and receiving the sensing signal and reflection signal.

At optional step 10, the UE/gNB sends the sensing data and/or the sensing result to the AF/initiator via the user plane/control plane as needed.

Before sending the sensing data and/or the sensing result, the UE/gNB may establish a transmission link with the AF or the initiator based on the address information included in the sensing parameter, and the sensing data and/or the sensing result may be sent via the transmission link.

As shown in FIG. 11, the embodiments of the present disclosure provide an apparatus for providing a sensing service, where the apparatus includes:
a first receiving module 110, configured to receive a sensing request, where the sensing request at least includes a UE identification and a base station identification;
a first determining module 120, configured to determine a target SF; and
a first sending module 130, configured to send the sensing request to the target SF.

The apparatus for providing the sensing service may be included in an AMF.

In some embodiments, the first receiving module 110, the first determining module 120, and the first sending module 130 may all be program modules; and the program module, when executed by a processor, is capable of implementing the functions of the modules described above.

In other embodiments, the first receiving module 110, the first determining module 120, and first sending module 130 may all be hardware software combination modules; the hardware software combination module includes, but is not limited to, a variety of programmable arrays; and the programmable array includes, but is not limited to, a field programmable array and/or a complex programmable array.

In still other embodiments, the first receiving module 110, the first determining module 120, and the first sending module 130 may be hardware-only modules; and the hardware-only module includes, but is not limited to, a specialized integrated circuit.

In some embodiments, the sensing request further includes sensing model information, where the sensing model information indicates a sensing model for use in providing the sensing service.

In these embodiments, the sensing model is:
a UE sending a sensing signal, and a base station receiving a reflection signal of the sensing signal sent by the UE; or
a base station sending a sensing signal, and a UE receiving a reflection signal of the sensing signal sent by the base station.

Of course, in some embodiments, the sensing model is not limited to sensing models where one of the UE or the base station serves as the sender and the other serves as the receiver. Other sensing models include, but are not limited to, the first sensing model, the second sensing model, and the fifth sensing model, etc. as mentioned above.

In some embodiments, the apparatus further includes a second determining module that is configured to determine whether a network supports providing the sensing service as requested; and the first determining module 120 is configured to determine the target SF if the sensing service as requested is supported.

In some embodiments, the second determining module is configured to perform at least one of:
determining whether the network supports provision of the sensing service; or
determining whether verification of the network side for providing the sensing service is passed.

In some embodiments, the second determining module is configured to: determine whether authority verification of the network side for the sensing service is passed; and/or determine whether privacy security verification of the network side for the sensing service is passed.

In some embodiments, the second determining module is configured to: send a query request to a UDM, where the query request at least carries the UE identification; and receive a query response returned based on the query request, where the query response is used for determining whether the verification is passed.

In some embodiments, the first determining module 120 is configured to: select, based on at least one of the sensing request, an SF selection configuration of the AMF or a network discovery mechanism, the target SF from candidate SFs capable of providing the sensing service.

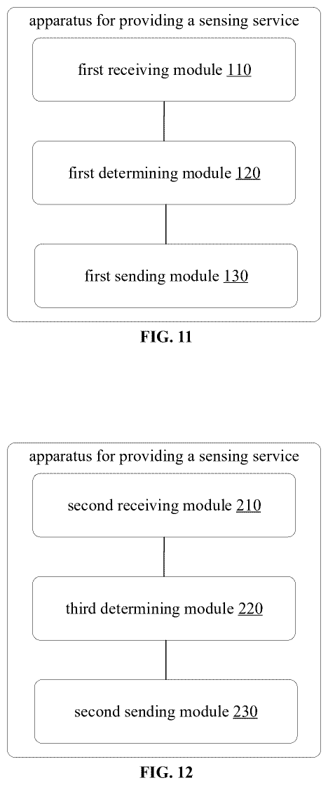

As shown in FIG. 12, the embodiments of the present disclosure provide an apparatus for providing a sensing service, where the apparatus includes:
a second receiving module 210, configured to receive a sensing request, where the sensing request at least includes a base station identification and a UE identification;
a third determining module 220, configured to determine a sensing parameter according to the sensing request; and
a second sending module 230, configured to send the sensing parameter to the UE and the base station.

The apparatus for providing the sensing service may be included in an SF.

In an embodiment, the second receiving module 210, the third determining module 220, and the second sending module 230 may all be program modules; and the program module, when executed by a processor, is capable of implementing the functions of the modules described above.

In another embodiment, the second receiving module 210, the third determining module 220, and the second sending module 230 may all be hardware software combination modules; the hardware software combination module includes, but is not limited to, a programmable array; and the programmable array includes a complex programmable array and/or a field programmable array.

In still another embodiment, the second receiving module 210, the third determining module 220, and the second sending module 230 may be hardware-only modules; and the hardware-only module includes, but is not limited to, a specialized integrated circuit.

In an embodiment, the sensing parameter includes:
a sending parameter when the UE is a sender, and a receiving parameter when the base station is a receiver; or
a receiving parameter when the UE is a receiver, and a sending parameter when the base station is a sender.

In an embodiment, the second sending module 230 is further configured to: when the UE is the sender and the base station is the receiver, send the sending parameter to the UE, and send the receiving parameter to the base station; or when the UE is the receiver and the base station is the sender, send the sending parameter to the base station, and send the receiving parameter to the UE.

In an embodiment, the sensing parameter further includes a processing parameter that is used for processing sensing data formed by a receiver through receiving a reflection signal.

In an embodiment, the determining the sensing parameter according to the sensing request includes determining the sensing parameter based on the sensing request and/or a policy parameter.

In an embodiment, the policy parameter includes a policy parameter locally stored in the SF, and/or a policy parameter provided by a PCF.

In an embodiment, the second sending module 230 is further configured to send a policy request message to the PCF; and the second receiving module 210 is further configured to receive a response message based on the policy request message, where the response message includes the policy parameter provided by the PCF.

In an embodiment, the apparatus further includes a verifying module that is configured to perform verification for an initiator of the sensing request; and the third determining module 220 is configured to: determine, after the verification is passed, the sensing parameter according to the sensing request.

In an embodiment, the verifying module is configured to: send a query request to a UDM; and receive a query response to the query request, where the query response is used for determining whether the verification is passed.

In an embodiment, the verification includes authority verification and/or privacy security verification.

In an embodiment, the second sending module 230 is configured to: send, based on the base station identification, a sensing response to the base station through an AMF, where the sensing response includes a portion of the sensing parameter sent to the base station and a portion of the sensing parameter sent to the UE, and the portion of the sensing parameter sent to the UE is sent to the UE.

In an embodiment, the sensing parameter further includes:
address information of an application function (AF), where the address information of the AF is used for the base station and/or the UE to establish a transmission link with the AF; and/or
address information of an initiator of the sensing service, where the address information of the initiator is used for the base station and/or the UE to establish a transmission link with the initiator.

In this embodiment, the transmission link as established is used for transmitting sensing data and/or a sensing result generated based on the sensing data.

In an embodiment, the sensing result includes an intermediate result and/or a final result.

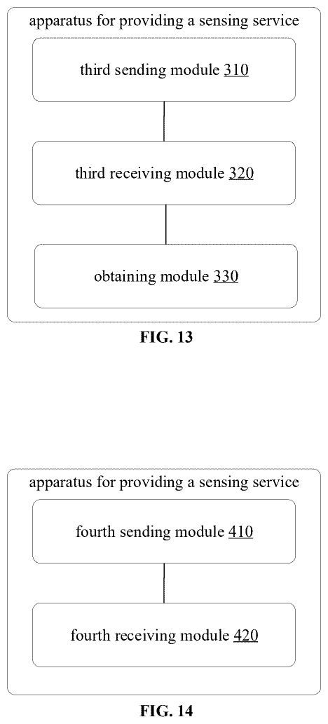

As shown in FIG. 13, the embodiments of the present disclosure provide an apparatus for providing a sensing service, where the apparatus includes:
a third sending module 310, configured to send to an AMF a sensing request that is from a UE;
a third receiving module 320, configured to receive a sensing response returned by an SF for the sensing request; and
an obtaining module 330, configured to obtain from the sensing response a sensing parameter used for the base station to provide the sensing service; where
the third sending module 310 is further configured to send to a UE a sensing parameter that is in the sensing response and used for the UE to provide the sensing service.

The apparatus for providing the sensing service may be included in a base station.

In an embodiment, the third sending module 310, the third receiving module 320, and the obtaining module 330 may all be program modules; and the program module, when executed by a processor, is capable of implementing the functions of the modules described above.

In another embodiment, the third sending module 310, the third receiving module 320, and the obtaining module 330 may all be hardware software combination modules; the hardware software combination module includes, but is not limited to, a programmable array; and the programmable array includes a complex programmable array and/or a field programmable array.

In still another embodiment, the third sending module 310, the third receiving module 320, and the obtaining module 330 may be hardware-only modules; and the hardware-only module includes, but is not limited to, a specialized integrated circuit.

In some embodiments, the third receiving module 320 is further configured to receive the sensing response returned by the SF for the sensing request and sent by the AMF.

In some embodiments, the apparatus further includes a first executing module, where the first executing module is configured to perform at least one of:
sending a sensing signal based on the sensing parameter used for the base station to provide the sensing service;
obtaining sensing data by receiving, based on the sensing parameter used for the base station to provide the sensing service, a reflection signal formed by reflection of a sensing signal sent by the UE; or
obtaining a sensing result by processing sensing data based on the sensing parameter used for the base station to provide the sensing service.

In some embodiments, the third sending module 310 is further configured to: send the sensing data to an application function (AF) or an initiator of the sensing service; or send the sensing result to the AF or the initiator of the sensing service.

In some embodiments, the sensing data or the sensing result is sent to the AF or the initiator via a user plane; or the sensing data or the sensing result is sent to the AF or the initiator via a control plane.

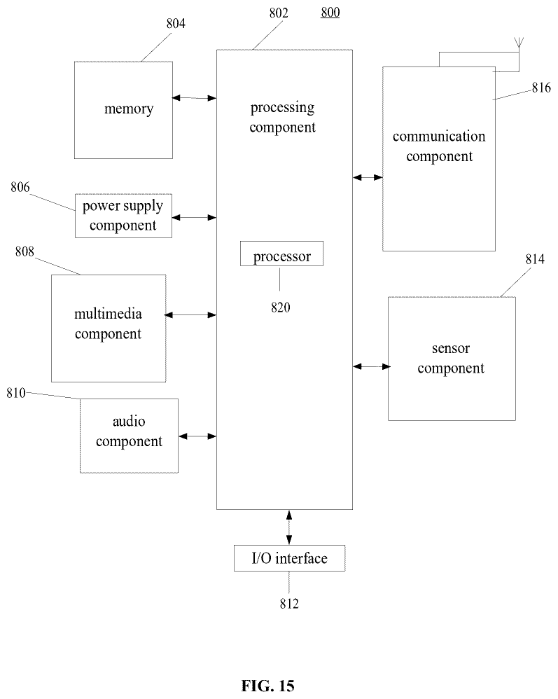

As shown in FIG. 14, the embodiments of the present disclosure provide an apparatus for providing a sensing service, where the apparatus includes:
a fourth sending module 410, configured to send through a base station a sensing request to an AMF, where the sensing request at least includes a UE identification and a base station identification, and is used for the AMF to determine a target SF for providing a sensing parameter required for the sensing service.

The apparatus for providing the sensing service is included in a UE.

In some embodiments, the fourth sending module 410 may be a program module; and the program module, when executed by a processor, sends to the AMF the sensing request including the UE identification and the base station identification.

In other embodiments, the fourth sending module 410 may be a hardware software combination module; and the hardware software combination module includes, but is not limited to, a field programmable array and/or a complex programmable array.

In still other embodiments, the fourth sending module 410 may be a hardware-only module; and the hardware-only module includes, but is not limited to, a specialized integrated circuit.

In some embodiments, the sensing request includes at least one of:
the UE identification;
sensing model information, indicating a sensing model of the sensing service;
QOS information, indicating QOS required for the sensing service;
the base station identification, indicating a base station requiring for providing the sensing service; or
target information of a sensing target.

In some embodiments, the apparatus further includes a fourth receiving module 420 that is configured to receive the sensing parameter sent by the base station, where the sensing parameter is from the target SF.

In some embodiments, the apparatus further includes a second executing module, where the second executing module is configured to perform at least one of:
sending a sensing signal based on a sending parameter in the sensing parameter;
obtaining sensing data by receiving a sensing signal based on a receiving parameter in the sensing parameter; or
obtaining a sensing result by processing the sensing data based on a processing parameter in the sensing parameter.

In some embodiments, the fourth sending module 410 is further configured to: send the sensing data to an application function (AF) or an initiator of the sensing service; or send the sensing result to the AF or the initiator of the sensing service.

The embodiments of the present disclosure provide a communication device including:
a memory configured to store a processor executable instruction; and
a processor, connected to the memory; where
the processor is configured to perform the control method and/or the information processing method of the terminal provided by any of the foregoing technical solutions.

The processor may include various types of storage media that are non-transitory computer storage media capable of continuing to memorize information stored therein after the communication device is powered down.

Herein, the communication device includes an access device, a UE or a core network device.

The processor may be connected to the memory via a bus or the like, and is configured to read the executable program stored in the memory, e.g. at least one of the methods shown in FIG. 3, FIGS. 6 to 8, FIGS. 9A to 9B, and FIG. 10.

FIG. 15 is a block diagram of a UE 800 illustrated according to an embodiment. For example, the UE 800 may be mobile phone, a computer, a digital broadcast user equipment, a message transceiver device, a game console, a tablet device, a medical device, a fitness device, a personal digital assistant, and the like.

Referring to FIG. 15, the UE 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the UE 800, such as operations associated with display, telephone calls, data communication, camera operations, and recording operations. The processing component 802 may include one or more processors 820 to execute an instruction to complete all or some of the steps of the methods described above. In addition, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support the operations at the UE 800. Examples of such data include the following for any application program or method operated on the UE 800: instructions, contact data, phonebook data, messages, pictures, videos, etc. The memory 804 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or a CD-ROM.

The power supply component 806 supplies power to various components of the UE 800. The power supply component 806 may include a power supply management system, one or more power supplies, and other components associated with generating, managing, and distributing power for the UE 800.

The multimedia component 808 includes a screen that provides an output interface between the UE 800 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of the touch or swipe action, but also detect the duration and pressure associated with the touch or swipe action. In some embodiments, the multimedia component 808 includes a front-facing camera and/or a rear-facing camera. The front-facing camera and/or the rear-facing camera may receive external multimedia data when the UE 800 is in an operating mode, such as a shooting mode or a video mode. Each of the front-facing camera and the rear-facing camera may be a fixed optical lens system or have a focal length and optical zoom capability.

The audio component 810 is configured to output and/or input audio signals. For example, the audio component 810 includes a microphone (MIC), configured to receive external audio signals when the UE 800 is in an operating mode, such as a calling mode, a recording mode, and a voice recognition mode. The received audio signals may be further stored in the memory 804 or sent via the communication component 816. In some embodiments, the audio component 810 further includes a speaker for outputting the audio signals.

The I/O interface 812 provides an interface between the processing component 802 and a peripheral interface module, and the peripheral interface module may be a keypad, a click wheel, a button, etc. These buttons may include, but are not limited to, a home button, a volume button, a start button, and a lock button.

The sensor component 814 includes one or more sensors configured to provide status assessment of various aspects of the UE 800. For example, the sensor component 814 may detect an open/closed state of the UE 800, relative positioning of the components, for example, the components are the display and small keypad of the UE 800, the sensor component 814 may also detect a change in the position of the UE 800 or a change in the position of one component of the UE 800, the presence or absence of user contact with the UE 800, the orientation or acceleration/deceleration of the UE 800, and temperature changes of the UE 800. The sensor component 814 may include a proximity sensor that is configured to detect the presence of nearby objects in the absence of any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate the communication between the UE 800 and other devices by wired or wireless means. The UE 800 may access a wireless network based on a communication standard, such as WiFi, 2G, 3G, or a combination thereof. In an exemplary embodiment, the communication component 816 receives broadcast signals or broadcast-related information from an external broadcast management system via a broadcast channel. In an exemplary embodiment, the communication component 816 further includes a near-field communication (NFC) module to facilitate short-range communication. For example, the NFC module may be implemented based on the radio frequency identification (RFID) technology, infrared data association (IrDA) technology, ultra-wideband (UWB) technology, bluetooth (BT) technology, and the like.

In an exemplary embodiment, the UE 800 may be implemented by one or more of: an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic element, to perform the above methods.

In an exemplary embodiment, a non-transitory computer-readable storage medium including an instruction is provided, such as the memory 804 including an instruction. The instruction described above is capable of being executed by the processor 820 of the UE 800 to complete the above methods. For example, the non-transitory computer-readable storage medium may be a ROM, a random access memory (RAM), a CD-ROM, a magnetic tape, a floppy disk, or an optical data storage device, etc.

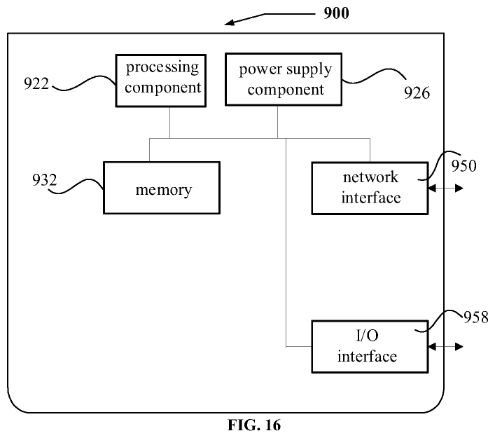

As shown in FIG. 16, an embodiment of the present disclosure illustrates a structure of an access device. For example, a communication device 900 may be provided as a network side device. The communication device may be the access device and/or the core network device as previously described.

Referring to FIG. 16, the communication device 900 includes: a processing component 922, where the processing component 922 further includes one or more processors, and a memory resource represented by a memory 932 for storing instructions, such as an application program, that may be executable by the processing component 922. The application program stored in the memory 932 may include one or more modules each corresponding to a set of instructions. In addition, the processing component 922 is configured to execute the instructions to perform any method described above applied to the access device, e.g., the methods shown in FIG. 3, FIGS. 6 to 8, FIGS. 9A to 9B, and FIG. 10.

The communication device 900 may further include a power supply component 926 configured to perform power management of the communication device 900, a wired or wireless network interface 950 configured to connect the communication device 900 to the network, and an I/O interface 958. The communication device 900 may operate an operating system stored in the memory 932, such as Windows Server™, Mac OS X™, Unix™, Linux™, FreeBSD™, or the like.

The embodiments of the present disclosure provide technical solutions in which the AMF, after receiving the sensing request, may determine the target SF for providing the sensing parameter, and then send the sensing request including the UE identification and the base station identification to the target SF, such that the target SF may determine, based on the UE identification and the base station identification carried in the sensing request, to introduce the base station and the UE into the provision system of the sensing service to provide the sensing service.

After considering the specification and practicing the invention disclosed herein, those skilled in the art will easily come up with other implementation solutions of the present invention. The present disclosure is intended to cover any variations, uses, or adaptive changes of the present invention, and the variations, uses, or adaptive changes follow the general principles of the present invention and include common knowledge or commonly used technical means in the technical field that are not disclosed in the present disclosure. The specification and embodiments are only considered to be illustrative, and the true scope and spirit of the present invention are indicated by the following claims.

It should be understood that the present invention is not limited to the precise structure which has been described above and illustrated in the accompanying drawings, and that various modifications and alterations may be made without departing from the scope of the present invention. The scope of the present invention is limited only by the appended claims.

1. A method for providing a sensing service, comprising:
receiving, by a first function, a first sensing request, wherein the first sensing request is used for requesting the sensing service;
determining, by the first function, a target second function; and
sending, by the first function, a second sensing request to the target second function according to the first sensing request.

2. The method according to claim 1, wherein the first sensing request or the second sensing request comprises:
sensing model information, wherein the sensing model information indicates a sensing model for use in providing the sensing service;
wherein the sensing model comprises:
a sensing model in which a base station sends a sensing signal and receives a reflection signal of the sensing signal sent by the base station;
a sensing model in which a user equipment (UE) sends a sensing signal and receives a reflection signal of the sensing signal sent by the UE;
a sensing model in which a UE sends a sensing signal, and a base station receives a reflection signal of the sensing signal sent by the UE; or
a sensing model in which a base station sends a sensing signal, and a UE receives a reflection signal of the sensing signal sent by the base station.

3. The method according to claim 1, further comprising:
determining whether a network supports providing the sensing service as requested.

4. The method according to claim 3, wherein the determining whether the network supports providing the sensing service as requested comprises at least one of:
determining whether the network supports provision of the sensing service; or
determining whether verification of the network for providing the sensing service is passed.

5. The method according to claim 4, wherein the determining whether the verification is passed comprises at least one of:
determining whether authority verification of the network for the sensing service is passed; or
determining whether privacy security verification of the network for the sensing service is passed.

6. The method according to claim 4, wherein the first sensing request or the second sensing request comprises at least one of a UE identification or a base station identification, and the determining whether the verification is passed comprises:
sending a query request to a user data management (UDM), wherein the query request carries at least one of the UE identification or the base station identification; and
receiving a query response returned based on the query request, wherein the query response is used for determining whether the verification is passed.

7. The method according to claim 1, wherein the determining the target second function comprises:
selecting, based on at least one of the first sensing request, a second function selection configuration of the first function or a network discovery mechanism, the target second function from candidate second functions capable of providing the sensing service.

8. A method for providing a sensing service, comprising:
receiving, by a second function, a second sensing request, wherein the second sensing request comprises at least one of a user equipment (UE) identification or a base station identification;
determining, by the second function, a sensing parameter according to the second sensing request; and
sending, by the second function, the sensing parameter to at least one of a UE corresponding to the UE identification or a base station corresponding to the base station identification.

9. The method according to claim 8, wherein the sensing parameter comprises:
a sending parameter for a sender, wherein the sender is one of the UE or the base station; and
a receiving parameter for a receiver, wherein the receiver is another one of the UE or the base station.

10. The method according to claim 9, wherein the sending the sensing parameter to at least one of the UE or the base station comprises:
when the UE is the sender and the base station is the receiver, sending the sending parameter to the UE, and sending the receiving parameter to the base station; or
when the UE is the receiver and the base station is the sender, sending the sending parameter to the base station, and sending the receiving parameter to the UE.

11. The method according to claim 8, wherein the sensing parameter comprises:
a processing parameter, used for processing sensing data formed by a receiver through receiving a reflection signal.

12. The method according to claim 8, wherein the determining the sensing parameter comprises:
determining the sensing parameter based on a policy parameter.

13. The method according to claim 12, wherein the policy parameter comprises at least one of:
a policy parameter locally stored in the second function; or
a policy parameter provided by a policy control function (PCF).

14. The method according to claim 13, further comprising:
sending a policy request message to the PCF; and
receiving a response message based on the policy request message, wherein the response message comprises the policy parameter provided by the PCF.

15. The method according to claim 8, further comprising:
performing verification for an initiator of the second sensing request; wherein
the determining the sensing parameter comprises:
determining, in response to the verification being passed, the sensing parameter.

16. The method according to claim 15, wherein the performing the verification for the initiator of the second sensing request comprises:
sending a query request to a user data management (UDM); and
receiving a query response to the query request, wherein the query response is used for determining whether the verification is passed;
or
wherein the verification comprises at least one of authority verification or privacy security verification.

17. (canceled)

18. The method according to claim 8, wherein the sending the sensing parameter to at least one of the UE or the base station comprises:
sending, based on the base station identification, a sensing response to the base station through a first function, wherein the sensing response comprises the sensing parameter, a portion of the sensing parameter is used for the base station to provide the sensing service, another portion of the sensing parameter is used for the UE to provide the sensing service, and the another portion of the sensing parameter is sent to the UE by the base station.

19. The method according to claim 8, wherein the sensing parameter comprises at least one of:
address information of an application function (AF), wherein the address information of the AF is used for at least one of the base station or the UE to establish a transmission link with the AF; or
address information of an initiator of the sensing service, wherein the address information of the initiator is used for at least one of the base station or the UE to establish a transmission link with the initiator;
wherein the transmission link is used for transmitting at least one of sensing data or a sensing result generated based on the sensing data; and
the sensing result comprises at least one of an intermediate result or a final result.

20-60. (canceled)

61. A communication device, comprising a processor, a transceiver, a memory, and an executable program stored in the memory and capable of being executed by the processor, wherein the processor, through executing the executable program is configured to:
receive a first sensing request, wherein the first sensing request is used for requesting a sensing service;
determine a target second function; and
send a second sensing request to the target second function according to the first sensing request.

62. (canceled)

63. A communication device, comprising a processor, a transceiver, a memory, and an executable program stored in the memory and capable of being executed by the processor, wherein the processor, through executing the executable program, is configured to perform the method according to claim 8.
